(19) United States
(12) Patent Application Publication
(10) Pub. No.: US 2025/0181800 A1
(43) Pub. Date: Jun. 5, 2025

(54) TOPOLOGY OPTIMIZATION WITH BIDIRECTIONAL MESH ADAPTATION

(71) Applicant: Siemens Energy Global GmbH & Co. KG, München (DE)

(72) Inventors: Tsz Ling Elaine Tang, Plainsboro, NJ (US); Songtao Xia, Lawrenceville, NJ (US); Karl-Johan Nogenmyr, Linghem (SE); Ramesh Subramanian, Oviedo, FL (US); Jose L. Rodriguez, Longwood, FL (US)

(21) Appl. No.: 18/726,423

(22) PCT Filed: Jan. 12, 2022
(86) PCT No.: PCT/CN2022/071651

§ 371 Date: Jul. 3, 2024

(51) Int. Cl. G06F 30/23; G06T 17/20

(52) U.S. Cl. CPC G06F 30/23; G06T 17/205

(57) ABSTRACT

Apparatus and method achieve topology optimization with bidirectional mesh adaptation. A mesh engine generates a mesh for a geometry of a computer aided design model of a design domain. A multi-physics simulator derives of physical field variables on the mesh based on material properties and boundary conditions of the design domain. An adjoint sensitivity is determined based on a given cost function and sensitivity formulation to drive a design variable lower or higher, the design variable defining a density of the design domain. An optimizer determines an optimization yielding a new set of design variables based on the adjoint sensitivity. A bidirectional mesh adaptation is performed on regions of the mesh by coarsening or refining the mesh element size. The multi-physics simulation, optimization and mesh adaptation are iteratively performed until optimized convergence criteria are met.

### TECHNICAL FIELD

This application relates to computer aided design and engineering. More particularly, this application relates to physics-based topology optimization with bidirectional mesh adaptation.

### BACKGROUND

Topology optimization has proven to be an effective method in generating conceptual designs where a design's material layout largely determines the efficiency of the product. Topology optimization enables generation of freeform designs, which can lead to improved performance based on the defined objectives and constraints. Topology optimization has been mostly applied in structural problems (e.g. minimizing structural compliance, minimize weight while satisfying stress constraints), and there have been growing advancements in extending this design approach to other types of physics (e.g. fluid flow, thermal-flow, electromagnetic, etc.).

More advanced topology optimization involves multiple evaluations of a design's functional performance via 2D/3D physics simulation, until the objective function is achieved and constraints are satisfied. Depending on the physics involved, as well as the number of objectives and constraints, this process can require exhaustive computational resources. For instance, gas turbine component designs often focus on thermal-flow topology optimization of heat transfer efficiency and flow performance more than structural objectives. Such simulations can be time-consuming, especially when the domain size is large. While a coarse mesh can be used to save computational time, it would compromise not only on the simulation accuracy, but also restrict the level of details of the resulting design features obtained from topology optimization. Thus, the optimal topology is sensitive to the mesh size being used.

One of the most common approaches to solving topology optimization problems is the density-based approach, for which the the design domain is discretized into mesh elements and the material properties of each element of the discretized domain is varied during the optimization. For example, in structural topology optimization, where the material property is density of a mesh element, an element can be defined with a value of 0 to represent void, a value of 1 to represent solid, and a fractional value to represent uncertain state with properties that lies between void and solid for a current optimization iteration. As the optimization progresses, each element moves toward a value 0 or value 1 to ultimately define each element as either void or solid.

The final topology obtained from such optimization is often not a smoothed surface (e.g., a voxelized surface when using structured mesh), and the quality of the resulting surface is largely dependent on the mesh size and quality. Hence, a mesh refinement of a coarse mesh size is desirable for such a density-based analysis. For example, an unrefined coarse mesh size will generate a geometry requiring great effort to smooth the surface in order to use it for subsequent analysis and 3D printing. However, an optimization using a mesh size too fine comes with extensive computational cost.

Previous studies have investigated adaptive mesh refinement as a strategy to selectively refine meshes used in topology optimization in order to reduce the costly use of a fine mesh within the design domain. The mesh refinement can be very dependent on the initial value for the design variable and might affect the results differently.

### SUMMARY

Apparatus and method are provided for topology optimization with bidirectional mesh adaptation based on both density-based variables and physics-based variables of the design domain. An initial model of the design domain is defined by a geometry with boundary conditions and objective functions. A topology mesh is defined for the model with an initial design variable field (e.g., the entire design domain is defined as either solid or fluid). A multi-physics simulator determines physics-based variables (e.g., temperature, pressure, velocity) based on material properties and boundary conditions of the current mesh. A sensitivity module determines adjoint sensitivity based on a defined cost function. An optimizer determines a new set of design variables based on the adjoint sensitivity, where the design domain is divided into fluid regions, solid regions and boundary regions. Bidirectional mesh adaptation is activated at regular intervals or irregular intervals of design optimization iterations. This process is iterated until the optimization convergence criteria is met, resulting in an optimal design.

### BRIEF DESCRIPTION OF THE DRAWINGS

Non-limiting and non-exhaustive embodiments of the present embodiments are described with reference to the following FIGURES, wherein like reference numerals refer to like elements throughout the drawings unless otherwise specified.

FIG. 1 is a block diagram for an example of a system to perform topology optimization with adaptive mesh resolution in accordance with embodiments of the disclosure.

FIG. 2 shows a flow diagram for an example of a topology optimization process with bidirectional mesh adaptation in accordance with embodiments of this disclosure.

FIG. 3 illustrates design variable fields for before and after mesh adaptation in accordance with embodiments of this disclosure.

FIG. 4 illustrates an example of a design domain for demonstrating topology optimization in accordance with embodiments of this disclosure.

FIGS. 5-7 shows topology optimization results for the example shown in FIG. 4.

FIG. 8 illustrates an example of a computing environment within which embodiments of the present disclosure may be implemented.

### DETAILED DESCRIPTION

Methods and apparatuses are disclosed for topology optimization with bidirectional mesh adaptation. Unlike prior works limited to refinement of an initially coarse mesh, the methods and apparatuses disclosed herein accelerate the convergence of design optimization by a selective mesh adaptation that both refines regions of the mesh and coarsens regions of the mesh according to detected gradients of design variables. An advantage of adaptive coarsening the mesh at regions away from fluid-solid boundaries and focused refinement at fluid-solid boundaries is to reduce the number of discretized elements which accelerates the computer-based analysis and conserves computation costs. An advantage of mesh refinement at regions near the fluid-solid boundaries is to obtain smoother design boundaries and also improve modeling accuracy. With focus on the gradient of the design variable, instead of the design variable value, the analysis is less dependent on the design variable field initialization than with prior works.

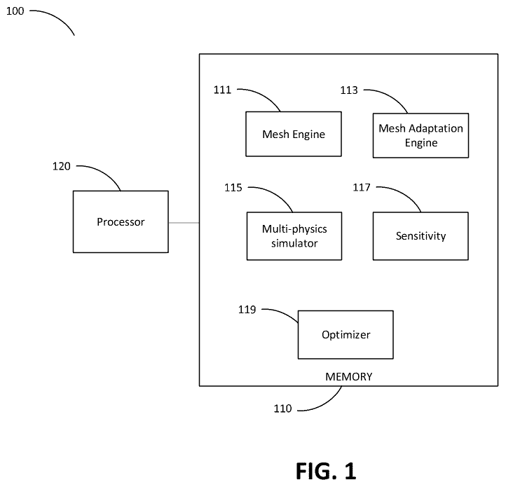

FIG. 1 is a block diagram for an example of a system to perform topology optimization with adaptive mesh resolution in accordance with embodiments of the disclosure. System 100 includes a computer processor 120 and memory 110 having stored thereon modular programmable instructions and algorithms with functionality to perform corrected topology optimization, including a mesh engine 111, a mesh adaptation engine 113, a multi-physics solver 115, a sensitivity module 117, and an optimizer engine 119.

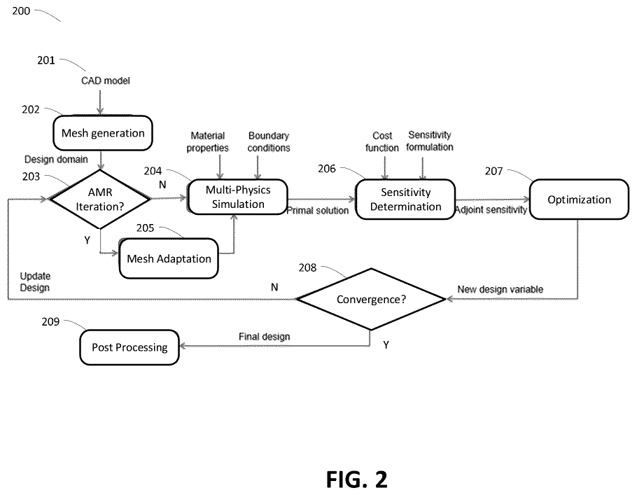

FIG. 2 shows a flow diagram for an example of a topology optimization process with bidirectional mesh adaptation in accordance with embodiments of this disclosure. Process 200 begins with a computer aided design (CAD) model 201 of the design domain received by mesh engine 111 which executes a mesh generation 202 of a geometry of the CAD model 201 while defining a design domain with boundary conditions and objective functions. Mesh engine 111 defines an initial mesh configuration on which an initial design variable (p (e.g., density) field is initialized. For example, in a physics-based setup for fluid dynamics, such as a heat exchanger, the design domain may be a metal enclosure structure with fluid inlet and outlet to extract heat from a target surface, where the design variable may be a variable density value d of each mesh element to represent either fluid (e.g., d=0) or solid metal of the structure (d=1). In an aspect, the initial design variable may be defined as fluid, such that the entirety of design domain mesh elements is set to d=0.

Multi-physics simulator 115 is configured to perform a multi-physics simulation 204 of physical field variables (e.g., temperature, velocity and pressure) on the original mesh based on material properties and boundary conditions of the design domain. In subsequent iterations, the multi-physics simulation 204 is performed for an adaptively refined mesh. An example for a multi-physics simulator 115 is Siemens Simcenter STAR-CCM+, however other similar simulators may be implemented. While thermal-flow simulations are presented herein for demonstrative purpose, the framework for the disclosed embodiments is also applicable to other types of physics-based problems (e.g., structural topology optimization).

Sensitivity module 117 is configured to receive a primal solution with simulation data from the multi-physics simulator 115 and to perform an adjoint sensitivity determination 206 based on a given cost function and sensitivity formulation. In an aspect, an adjoint solution is computed with accounting for the design variable and physical variable field. A cost function may be defined by minimum/maximum temperature, pressure, or other constraints. Sensitivity formulation may compute gradient of how the objective will change the design variable for each mesh element. In an embodiment, each mesh element is assigned a sensitivity of +, −, or 0 value, indicating which direction to drive the design variable, such as lower (−), higher (+), or no change (0).

Optimizer 119 is configured to take the adjoint sensitivity as input along with current design variables to determine an optimization 207 yielding a new set of design variables. In an embodiment, optimizer 119 is configured to execute an optimization algorithm that may include a moving average asymptote based on design variable history. During the optimization iterations, optimizer 119 determines the design value for each mesh element, moving toward 0 or 1. For example, in fluid dynamics simulation, the design variable may represent density of the design domain element, with the fluid regions represented by design variable value of 0, the solid regions by a value of 1, and uncertain regions having a value between 0 and 1.

Process 200 is iterated until optimization convergence criteria is met (e.g., one or more physics-based objective values converges), resulting in an optimal design. At decision 208, if convergence is detected, the final design is sent to post processing 209, such as for finalizing the topology of the design domain using CAD based tools for smoothing to yield a practical design. If convergence has not yet occurred, a decision for bidirectional mesh adaptation 203 is made according to a regular interval (e.g., every iteration or every n^{th} iteration) or varying intervals (e.g., setting a series of variable time windows for a series of refinements for cost savings by fewer refined computations). Varying intervals may be controlled by setting conditions on detected properties of the mesh topology design variables. For example, input parameters may be defined for degree of coarsening and refinement in response to detected gradients of design variables, where mesh adaptation occurs only upon detection of a gradient threshold. In this instance, the design variable gradient threshold controls the variable interval of mesh adaptation.

In response to a positive decision for bidirectional mesh adaptation 203, mesh adaptation engine 113 is activated and configured to perform a bidirectional mesh adaptation 205. Criteria for bidirectional mesh adaptation are defined to identify mesh elements that need to be refined or coarsened. In topology optimization, especially for thermal-flow problems, refining the elements near the fluid-solid (or void-solid) boundaries improves the resolution of the design, and improves the modeling accuracy. On the other hand, coarsening the elements further away from the boundary (e.g., regions that already converged into solid in thermal-flow topology optimization), can also help save computational cost, since those are the regions that have lesser impact on the final design topology.

In an embodiment, the mesh adaptation engine 113 defines a mesh adaptation variable (γ) to distinguish the target mesh elements for refinement or coarsening in the design domain. Variable γ is the product of the magnitude of the gradient of the design variable field (|∇φ|), and the element size (h,defined as cubic root of element volume). The mesh adaptation variable for each element i can be represented as follows:

$${γ ( φ , h )}_{i} = {\vert ∇ φ \vert}_{i} \cdot {h}_{i} where {h}_{i} = \sqrt[3]{{( Element volume )}_{i}} \qquad Eq . ( 1 )$$

For mesh elements at the fluid-solid boundaries, since the design variables are at the lower and upper bounds (0 and 1), it is expected that these elements have the highest design variable gradients, hence higher γ values. On the other hand, for the elements away from the fluid-solid interfaces (e.g., solid element next to another solid element), the design variable gradient will be zero, i.e., γ=0. The magnitude of the design variable gradient is also multiplied by its element size to account for coarsened/refined element sizes. To isolate the boundary region of the mesh, mesh adaptation criteria for a lower bound γ_{low} and an upper bound γᵤₚ are defined for variable γ to identify elements for refinement or coarsening, as presented in Table 1.

TABLE 1
Mesh adaptation criteria for refinement and coarsening

| Mesh adaptation | |
|---|---|
| criteria | Mesh adaptation |
| γᵢ < γ_{low} | Coarsen mesh |
| γ_{low} < γᵢ < γᵤₚ | Keep mesh size |
| γᵢ > γᵤₚ | Refine mesh |

For convergence decision 208, as well as to provide design variable history input for the optimization algorithm (e.g., moving average asymptote), the design variable history before mesh adaptation needs to be preserved. In this case, to make sure the evolution of the design variable is maintained in the refined mesh elements, the mesh adaptation engine 113 preserves design variable field and design variable history field before and after refinement by subdividing a coarse element into multiple finer elements. No interpolation or smoothing is performed on the refined elements. Both the coarse and fine elements share the same design variable and design variable history. Likewise, the design variable field and design variable history field are preserved before and after coarsening by coarsening a set of fine elements into a single coarse element.

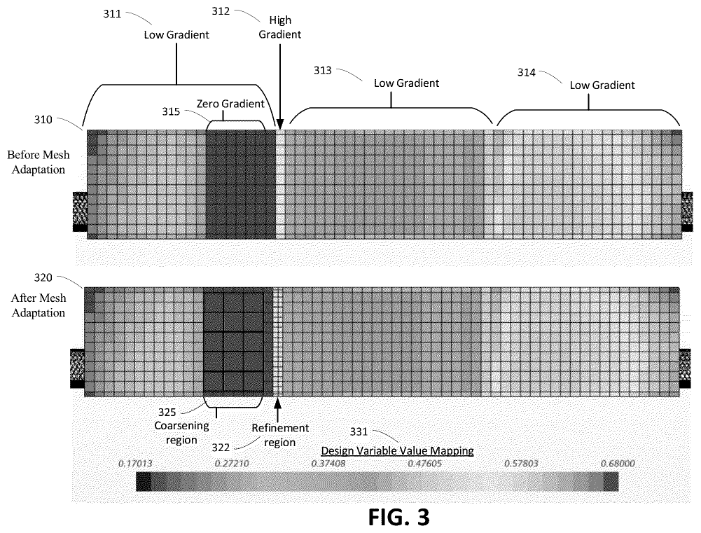

FIG. 3 illustrates design variable fields for before and after mesh adaptation in accordance with embodiments of this disclosure. In this example, a 2D rendering is presented as a portion of the 3D design variable field (i.e., a vertical slice from inlet to outlet). An initial design variable field 310 is mapped according to a design variable value mapping 331. Low gradient region 311 has design variable values between 0.61 and 0.68 (gradient˜0.00 to 0.07 for adjacent elements) and low gradient region 313 has design variable values between 0.38 and 0.46 (gradient˜0.00 to 0.08 for adjacent elements). High gradient region 312 exhibits the highest gradient for the design variable field 310, with a gradient˜0.26. In accordance with mesh adaptation criteria, the elements of high gradient region 312 are targeted as a mesh refinement region by the mesh adaptation engine 113. Accordingly, design variable field after mesh adaptation 320 shows a refinement of elements in refinement region 322. In an aspect, mesh adaptation can be bidirectional in a single iteration, such that for mesh elements in low gradient regions 311, 313, 314 that exhibit gradient value γᵢ less than the lower bound γ_{low} can be coarsened simultaneously with mesh refinement of mesh elements in refinement region 322. For example, zero gradient region 315 is targeted as a coarsening region, and as shown design variable field 320 in after mesh adaptation, the mesh elements are coarsened within coarsening region 325.

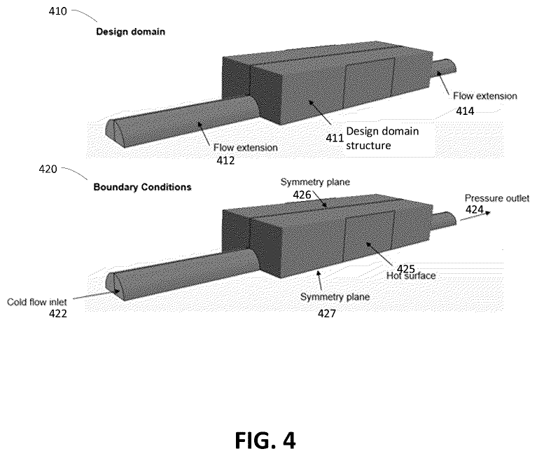

FIG. 4 illustrates an example of a design domain for demonstrating topology optimization in accordance with embodiments of this disclosure. For this example implementation, a thermal-flow topology optimization case is demonstrated. In an embodiment, multiple physics-based objectives are defined for the simulation. In this example, a design domain 410 is defined for a cooling channel design with multiple objectives: (i) minimize pressure drop and, (ii) minimize volume average temperature. A design structure 411 represents a heat exchange chamber (e.g., of a metallic substance) within which a fluid is to flow for carrying away the heat of a hot surface. Flow extensions 412, 414 are attached to the design domain for fluid inlet and outlet, respectively. In an embodiment, various boundary conditions are defined for the design domain, such as structural and geometric. In this example, boundary conditions 420 include a symmetry planes 426, 427, a hot surface 425, cold water inlet 422 and pressure outlet 424. As shown in FIG. 4, only half of the topology around symmetry plane 427 is shown for illustrative purpose. Actual simulations may visualize the entire topology. To simulate this model, a CAD model of the geometry for design domain 410 is meshed by mesh engine 111. Multi-physics simulator 115 simulates the fluid flow from inlet to outlet, and estimates pressure drop and average temperature throughout the mesh.

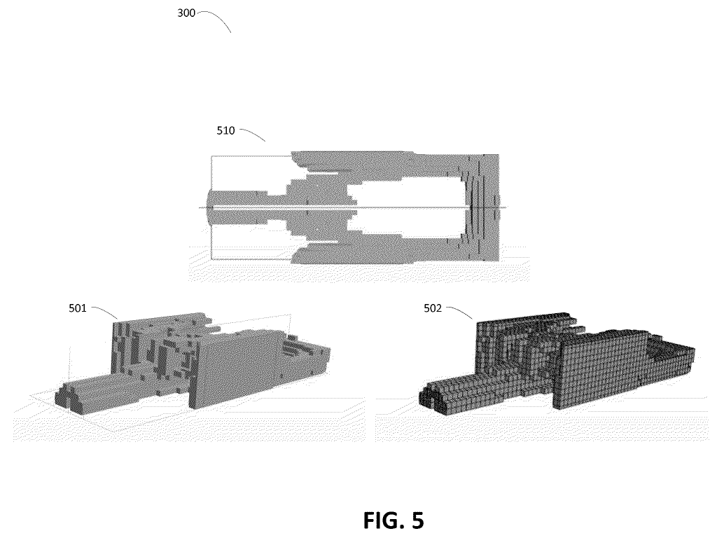

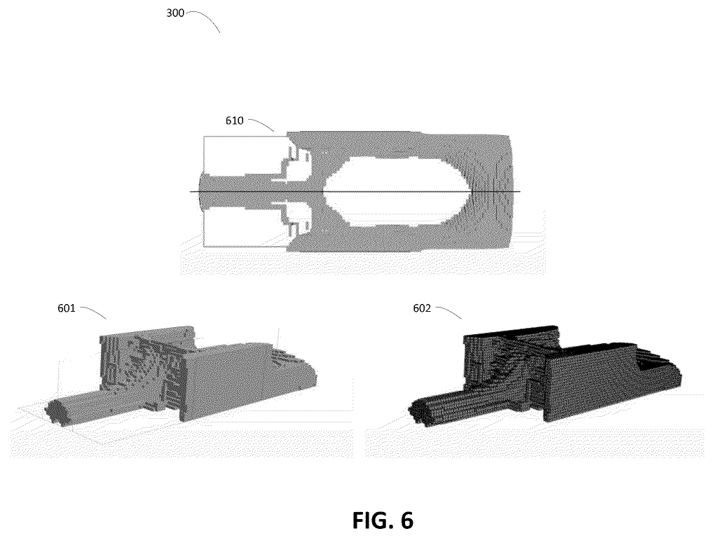

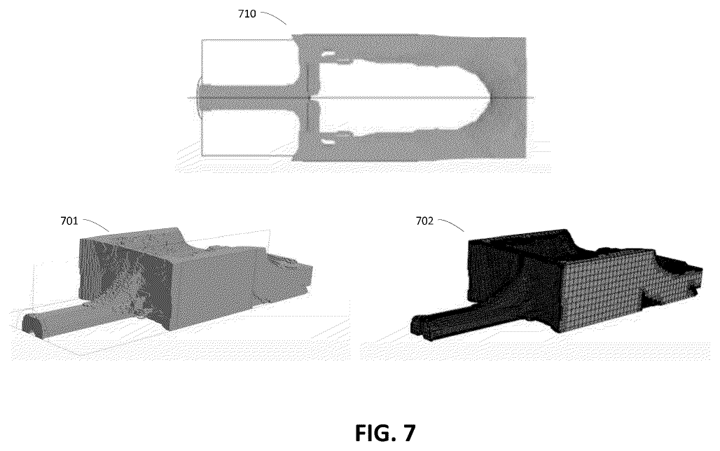

Topology optimization results of three different runs for the setup of FIG. 4 are illustrated in FIGS. 5-7, shown as visualizations of the final design variables representing fluid. The displayed topology represents the fluid-solid boundary, with the solid material displayed as void for demonstrative purpose. Cases 1 and 2 are baseline trials for comparison against the disclosed framework executed for Case 3. As shown in FIG. 5, a coarse mesh 502 was used in Case 1, fixed at 2 mm edge length, without mesh adaptation for the optimization, producing the fluid topology 501 with top view 510. FIG. 6 shows the results for Case 2, in which a fine mesh 602 was used throughout the optimization, fixed at 1 mm edge length, without mesh adaptation, producing the fluid topology 601 with top view 610. In FIG. 7, the mesh adaptation was applied in Case 3, starting with the 2 mm coarse mesh of Case 1 and applying mesh adaptation criteria as follows. A maximum mesh refinement level of 2 was applied, with available element size of 2 mm, 1 mm, 0.5 mm, starting mesh adaptation at optimization iteration 5, and adapting mesh at every 5 optimization iterations. As shown in FIG. 7, layers of fine elements are observed near the fluid-solid interface of the mesh 702, yielding an optimized design 701, with top view 710. In regions away from the fluid-solid interface (internal to the mesh geometry 702, and hidden from view in FIG. 7), coarse elements were applied. The original mesh for the optimization iterations was defined by 8,640 mesh elements, peaking at 105,612 elements during the optimization, and ending up at 71,014 elements upon convergence for the final design. An overall smoother geometry is observed in the resulting model 701/710 compared to the baseline models 501/510, 601/610 due to the fine layers of mesh elements near the fluid-solid boundary.

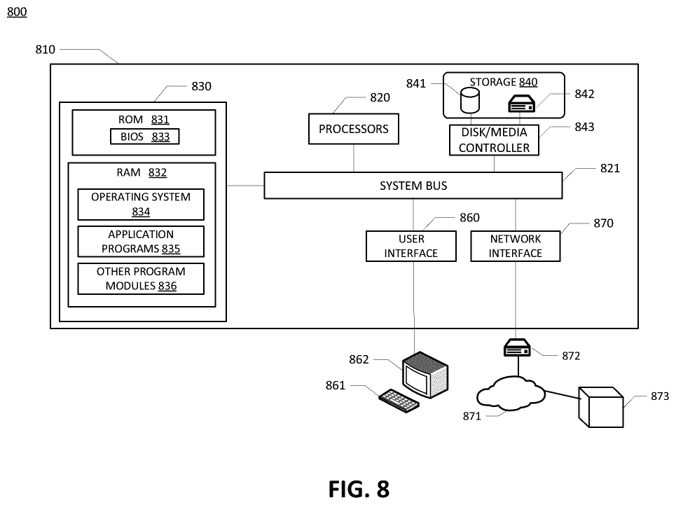

FIG. 8 illustrates an example of a computing environment within which embodiments of the present disclosure may be implemented. A computing environment 800 includes a computer system 810 that may include a communication mechanism such as a system bus 821 or other communication mechanism for communicating information within the computer system 810. The computer system 810 further includes one or more processors 820 coupled with the system bus 821 for processing the information. In an embodiment, computing environment 800 corresponds to system 100 as shown in FIG. 1 for topology optimization with adaptive mesh resolution, in which the computer system 810 relates to a computer described below in greater detail.

The processors 820 may include one or more central processing units (CPUs), graphical processing units (GPUs), or any other processor known in the art. More generally, a processor as described herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 820 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor may be capable of supporting any of a variety of instruction sets. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

The system bus 821 may include at least one of a system bus, a memory bus, an address bus, or a message bus, and may permit exchange of information (e.g., data (including computer-executable code), signaling, etc.) between various components of the computer system 810. The system bus 821 may include, without limitation, a memory bus or a memory controller, a peripheral bus, an accelerated graphics port, and so forth. The system bus 821 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

Continuing with reference to FIG. 8, the computer system 810 may also include a system memory 830 coupled to the system bus 821 for storing information and instructions to be executed by processors 820. The system memory 830 may include computer readable storage media in the form of volatile and/or nonvolatile memory, such as read only memory (ROM) 831 and/or random access memory (RAM) 832. The RAM 832 may include other dynamic storage device(s) (e.g., dynamic RAM, static RAM, and synchronous DRAM). The ROM 831 may include other static storage device(s) (e.g., programmable ROM, erasable PROM, and electrically erasable PROM). In addition, the system memory 830 may be used for storing temporary variables or other intermediate information during the execution of instructions by the processors 820. A basic input/output system 833 (BIOS) containing the basic routines that help to transfer information between elements within computer system 810, such as during start-up, may be stored in the ROM 831. RAM 832 may contain data and/or program modules that are immediately accessible to and/or presently being operated on by the processors 820. System memory 830 may additionally include, for example, operating system 834, application modules 835, and other program modules 836. Application modules 835 may include aforementioned mesh engine 111, mesh adaptation engine 113, multi-physics simulator 115, sensitivity module 117 and optimizer 119 shown in FIG. 1 and may also include a user portal for development of the application program, allowing input parameters to be entered and modified as necessary.

The operating system 834 may be loaded into the memory 830 and may provide an interface between other application software executing on the computer system 810 and hardware resources of the computer system 810. More specifically, the operating system 834 may include a set of computer-executable instructions for managing hardware resources of the computer system 810 and for providing common services to other application programs (e.g., managing memory allocation among various application programs). In certain example embodiments, the operating system 834 may control execution of one or more of the program modules depicted as being stored in the data storage 840. The operating system 834 may include any operating system now known or which may be developed in the future including, but not limited to, any server operating system, any mainframe operating system, or any other proprietary or non-proprietary operating system.

The computer system 810 may also include a disk/media controller 843 coupled to the system bus 821 to control one or more storage devices for storing information and instructions, such as a magnetic hard disk 841 and/or a removable media drive 842 (e.g., floppy disk drive, compact disc drive, tape drive, flash drive, and/or solid state drive). Storage devices 840 may be added to the computer system 810 using an appropriate device interface (e.g., a small computer system interface (SCSI), integrated device electronics (IDE), Universal Serial Bus (USB), or FireWire). Storage devices 841, 842 may be external to the computer system 810.

The computer system 810 may include a user interface module 860 to process user inputs from user input devices 861, which may comprise one or more devices such as a keyboard, touchscreen, tablet and/or a pointing device, for interacting with a computer user and providing information to the processors 820. User interface module 860 also processes system outputs to user display devices 862, (e.g., via an interactive a graphical user interface (GUI) display).

The computer system 810 may perform a portion or all of the processing steps of embodiments of the invention in response to the processors 820 executing one or more sequences of one or more instructions contained in a memory, such as the system memory 830. Such instructions may be read into the system memory 830 from another computer readable medium of storage 840, such as the magnetic hard disk 841 or the removable media drive 842. The magnetic hard disk 841 and/or removable media drive 842 may contain one or more data stores and data files used by embodiments of the present disclosure. The data store 840 may include, but are not limited to, databases (e.g., relational, object-oriented, etc.), file systems, flat files, distributed data stores in which data is stored on more than one node of a computer network, peer-to-peer network data stores, or the like. Data store contents and data files may be encrypted to improve security. The processors 820 may also be employed in a multi-processing arrangement to execute the one or more sequences of instructions contained in system memory 830. In alternative embodiments, hard-wired circuitry may be used in place of or in combination with software instructions. Thus, embodiments are not limited to any specific combination of hardware circuitry and software.

As stated above, the computer system 810 may include at least one computer readable medium or memory for holding instructions programmed according to embodiments of the invention and for containing data structures, tables, records, or other data described herein. The term “computer readable medium” as used herein refers to any medium that participates in providing instructions to the processors 820 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 841 or removable media drive 842. Non-limiting examples of volatile media include dynamic memory, such as system memory 830. Non-limiting examples of transmission media include coaxial cables, copper wire, and fiber optics, including the wires that make up the system bus 821. Transmission media may also take the form of acoustic or light waves, such as those generated during radio wave and infrared data communications.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the users computer and partly on a remote computer or entirely on the remote computer or server. In the latter scenario, the remote computer may be connected to the users computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable medium instructions.

The computing environment 800 may further include the computer system 810 operating in a networked environment using logical connections to one or more remote computers, such as remote computing device 873. The network interface 870 may enable communication, for example, with other remote devices 873 or systems and/or the storage devices 841, 842 via the network 871. Remote computing device 873 may be a personal computer (laptop or desktop), a mobile device, a server, a router, a network PC, a peer device or other common network node, and typically includes many or all of the elements described above relative to computer system 810. When used in a networking environment, computer system 810 may include modem 872 for establishing communications over a network 871, such as the Internet. Modem 872 may be connected to system bus 821 via user network interface 870, or via another appropriate mechanism.

Network 871 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 810 and other computers (e.g., remote computing device 873). The network 871 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 871.

It should be appreciated that the program modules, applications, computer-executable instructions, code, or the like depicted in FIG. 8 as being stored in the system memory 830 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computer system 810, the remote device 873, and/or hosted on other computing device(s) accessible via one or more of the network(s) 871, may be provided to support functionality provided by the program modules, applications, or computer-executable code depicted in FIG. 8 and/or additional or alternate functionality. Further, functionality may be modularized differently such that processing described as being supported collectively by the collection of program modules depicted in FIG. 8 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 8 may be implemented, at least partially, in hardware and/or firmware across any number of devices.

It should further be appreciated that the computer system 810 may include alternate and/or additional hardware, software, or firmware components beyond those described or depicted without departing from the scope of the disclosure. While various illustrative program modules have been depicted and described as software modules stored in system memory 830, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules. Accordingly, the phrase “based on,” or variants thereof, should be interpreted as “based at least in part on.”

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. An apparatus for topology optimization, comprising:
a memory having modules stored thereon; and
a processor for performing executable instructions in the modules stored on the memory, the modules comprising:
a mesh engine configured to generate a mesh for a geometry of a computer aided design model of a design domain, wherein the mesh comprises mesh elements with a defined mesh element size;
a multi-physics simulator configured to perform a multi-physics simulation of physical field variables on the mesh based on material properties and boundary conditions of the design domain;
a sensitivity module configured to receive simulation data from the multi-physics simulator to perform an adjoint sensitivity determination based on a given cost function and sensitivity formulation, wherein the sensitivity formulation assigns a sensitivity value for each mesh element to drive a design variable lower or higher, wherein the design variable defines a density of the design domain;
an optimizer configured to take the adjoint sensitivity as input along with current design variables to determine an optimization yielding a new set of design variables; and
a mesh adaptation engine configured to perform a bidirectional mesh adaptation in regions of the mesh by coarsening or refining the mesh element size;
wherein the multi-physics simulation, optimization and mesh adaptation are iteratively performed until optimized convergence criteria are met.

2. The apparatus of claim 1, wherein the mesh adaptation is set to occur according to a regular interval.

3. The apparatus of claim 1, wherein the mesh adaptation is set to occur according to varying intervals controlled by setting conditions on detected properties of the design variables.

4. The apparatus of claim 1, wherein the mesh adaptation engine defines a mesh adaptation variable to distinguish target mesh elements for mesh adaptation, wherein for each mesh element, the mesh adaptation variable is a product of the magnitude of design variable field gradient and mesh element size.

5. The apparatus of claim 4, wherein the mesh adaptation engine determines a coarsening for mesh elements having a mesh adaptation variable less than a lower bound, and a refinement for mesh elements having a mesh adaptation variable greater than an upper bound.

6. The apparatus of claim 1, wherein the mesh adaptation engine preserves design variable history by subdividing a coarse mesh element into multiple finer elements, wherein the coarse element and subdivided elements share the same design variable and design variable history.

7. A method for topology optimization, comprising:
generating a mesh for a geometry of a computer aided design model of a design domain, wherein the mesh comprises mesh elements with a defined mesh element size;
performing a multi-physics simulation of physical field variables on the mesh based on material properties and boundary conditions of the design domain;
performing an adjoint sensitivity determination using received simulation data, the sensitivity being based on a given cost function and sensitivity formulation, wherein the sensitivity formulation assigns a sensitivity value for each mesh element to drive a design variable lower or higher, wherein the design variable defines a density of the design domain;
determining an optimization yielding a new set of design variables based on the adjoint sensitivity; and
performing a bidirectional mesh adaptation in regions of the mesh by coarsening or refining the mesh element size;
wherein the multi-physics simulation, optimization and mesh adaptation are iteratively performed until optimized convergence criteria are met.

8. The method of claim 7, wherein the mesh adaptation is set to occur according to a regular interval.

9. The method of claim 7, wherein the mesh adaptation is set to occur according to varying intervals controlled by setting conditions on detected properties of the design variables.

10. The method of claim 7, wherein the mesh adaptation includes defining a mesh adaptation variable to distinguish target mesh elements for mesh adaptation, wherein for each mesh element, the mesh adaptation variable is a product of the magnitude of design variable field gradient and mesh element size.

11. The method of claim 10, wherein the mesh adaptation includes determining a coarsening for mesh elements having a mesh adaptation variable less than a lower bound, and a refinement for mesh elements having a mesh adaptation variable greater than an upper bound.

12. The method of claim 7, wherein the mesh adaptation includes preserving design variable history by subdividing a coarse mesh element into multiple finer elements, wherein the coarse element and subdivided elements share the same design variable and design variable history.
